(19) United States
(12) Patent Application Publication
(10) Pub. No.: US 2005/0009417 A1
(43) Pub. Date: Jan. 13, 2005

(54) Isomorphism method and apparatus

(76) Inventor: Uwe Meding, Allen, TX (US)

Correspondence Address: CARR LAW FIRM, L.L.P., 670 FOUNDERS SQUARE, 900 JACKSON STREET, DALLAS, TX, 75202, US

(21) Appl. No.: 10/616,215

(22) Filed: Jul. 9, 2003

(51) Int. Cl. H01R 9/22

(52) U.S. Cl. 439/894

(57) ABSTRACT

Disclosed is an algorithm and a computation system that, when using the stated simplification approach, can heuristically or iteratively determine identicalness of two electric circuits by setting a minimum network scope value and: FIRST, generating signatures defining interconnected circuit components of the set scope value and having a prime vertex; SECOND, determining which of those signatures are unique to a source circuit; THIRD, eliminating from further consideration unique signature vertices that match with a signature in the target circuit; and FOURTH, moving to an identicalness discrepancy list those unique signature vertices that do not match. Then, repeating the process with incremented scope values until only symmetrical and unevaluated vertices remain to be matched or added to the discrepancy list.

### TECHNICAL FIELD

The invention relates to obtaining an indication of the identicalness of two electrical circuits.

### BACKGROUND

There are numerous situations where it may be desirable for a first company, or other entity, to provide product application data to one or more second entities that may wish to use the data to build products that support or interact with all or portions of this product application data. The product application data can be in the form of schematic reference designs for electronic components. The schematic reference designs are typically entered using CAD (computer aided design) systems that allow for the capture of the graphical depiction of an electronic design, as well as the creation of the corresponding connectivity that represents the electrical connections between components. Exchanging these designs represents a great opportunity for the supplying company to enhance its market presence for components used in these designs. Also companies using these reference boards gain great advantages by being able to utilize the intellectual property directly in the products they create.

The biggest issues arise out of resolving the idiosyncrasies of exchanging the data sets and the challenge to import these back into a CAD system. This is especially a problem where the CAD system is different from the CAD: system that originally created the circuit. In such a situation, the reference designs need to be converted between the two different CAD systems. Because of differences in CAD systems, precautions are required to make sure that the semantics of the electrical connections are translated correctly. For this purpose, it is advantageous to have a capability to compare the connectivity of the original design with the converted design. Such a comparison, in complicated circuits, involves many components and connections, and a human based comparison will typically involve errors.

In software implementations, electronic circuits are represented using various approaches that are derived from the graph theory. This transformation is accomplished using any of various prior art techniques. As will be apparent to persons skilled in the art, in graph theory, comparing two graphs for identicalness is also known as “graph isomorphism.”

It may be noted that, in general, a graph isomorphism problem is very complex. In fact, it is not known to have a general solution in the prior art. It has been determined that the complexity of a generic solution would put it almost into the class of NP (non-polynomial) problems. (See. Skiena, S., Implementing Discrete Mathematics: Combinatorics and Graph Theory with Mathematica®, pp. 181-187, Addison-Wesley (1990). Also, see Kobler, J., Schöning, U. and Torán, J. The Graph Isomorphism Problem: Its Structural Complexity, pp. 11-25, Birkhäuser (1993).) Problems that live in this class typically will take a decidedly long time to iterate through all required permutations to find a solution. For example, even a small circuit with 100 vertices will exceed the enumeration required for all particles in the known universe. However, there are many electronic circuits that define many more vertices. Checking whether a given vertex bijection is an isomorphism would require an examination of all vertex pairs, which itself is not overwhelming. However, since one would need to check n! vertex bijections for determining general graph isomorphism, it makes this a difficult problem to solve.

It would be desirable to have a computer program based upon an algorithm that can accomplish such checking of identicalness list the discrepancies between two circuits and accomplish same upon present day computers.

### SUMMARY OF THE INVENTION

The present invention comprises using a computer to find and set forth discrepancies from identicalness of two circuits.

### BRIEF DESCRIPTION OF THE DRAWINGS

For a more complete understanding of the present invention, and its advantages, reference will now be made in the following Detailed Description to the accompanying drawings, in which:

FIGS. 1A & 1B comprise the main flow diagram for determining isomorphism;

FIGS. 2; 3A, 3B, 4A, 4B, 5A, and 5B are expansions of the broader blocks shown in FIG. 1;

FIG. 6 is a block diagram schematical network description of a simple electronic circuit;

FIG. 7 comprises a graphical representation (sometimes known as a digraph) of FIG. 6;

FIGS. 8 and 9 are modified graph illustrations used to explain the terms scope as used in the algorithm of the present invention; and

FIG. 10 is a processing system in which the vertex processing can be performed.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the: most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein may be performed in either hardware or software, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

In the remainder of this description, the term “vertex” by definition comprises one or more components connected in an inverted-tree fashion (i.e., family tree) with a global scope of N where N commences with a value of “0” for a single prime component with no connected components. Thus, a “prime component” is the component at the uppermost portion of the inverted tree or vertex. A vertex having a scope of N=1 has a single layer of additional components connected to each lead of the prime component. Further, a vertex having a scope of N=2 has another layer of components connected to each of the leads of the layer above, and so forth.

The term “scope,” by definition, is indicative of the number of layers of components added to a prime component to define a “unique vertex.”

The term “unique vertex,” by definition, is indicative of a prime component, or a prime component with one or more layers of additional connected components, that is different from all other vertexes in a given circuit.

The term “signature,” is intended to comprise a defining description of all the components and their, interconnections comprising a vertex of a given, scope.

The term “net” is intended to comprise the components and the interconnections forming a vertex of a given scope.

In the algorithm presented herein, certain heuristics have been employed to solve the comparison problem timely and reliably. For the content of the electrical connectivity, the following observations can be made:

1. An edge or electrical connection, from a component to another component, power terminal, ground and so forth, has two, endpoints of which (by definition) one end point always points to an instance vertex end point and the other to the net vertex end point.

2. The instance vertex end point corresponds to a component instance pin in the electrical connectivity domain. The nature of CAD design dictates that a component pin must be unique. This means that a corresponding instance pin must also be unique.

3. The net vertex main function is to build the connection point between instance pins. In that sense, the net vertex end points correspond also to the component instance/pin tuple in the electrical connectivity. Again, by nature of the CAD design, these tuples are unique.

With these observations, one can say the edge multiplicity is always 1. This represents a great simplification of the problem. It means that once a pair of edges can be matched, one does not need to look for further matches.

Vertices (components), have no properties like that to help distinguish them from each other. Instance names or reference designators cannot be assumed to match up by default, because different sources and targets will have different conventions. Net names cannot be assumed to match up by default. Net names may have been renamed following different conventions or, alternatively, nets may be unnamed by the source system.

However, the following observations can be made:

1. The instance vertices are derived from the actual instances in the net list or-schematic; however, the instance names (or reference designators) can be different between different sets of connectivity without changing the functionality.

2. The net vertices are derived from the actual wires in the net list or schematic; however, net names (or net name aliases) can be different between different sets of connectivity.

Given these observations, a signature can be generated for each component vertex that contains and includes the component instance connections. The signatures of the net vertices may be calculated from the signatures of the component instance pins that are connected by this net.

On a high level, the methods described in the present invention determine isomorphism between two graphs, by assigning a signature to instance vertex end points. These signatures are derived from the master components connections that are represented by this instance. The signatures on the instance vertex end points are used to create a signature for the instance vertex. The instance vertex end point signatures are then used to create a net vertex signature. Unique signatures in both graphs represent the same vertex, therefore representing an isomorphism. The signatures on the remaining vertices are recalculated by expanding the scope of neighbor vertices for a given vertex. Continual expansion of the scope of a given neighborhood around a vertex is used to determine the signature of this vertex until it becomes unique.

From the above, it may be ascertained that the signature of a vertex is a function of all the edges (connection points or leads) that are attached to it. The edges on vertices correlate to the pin names of the component. For the present algorithm, it is not actually important how the signature is calculated, as long as it can be uniquely determined and is the same for the same input. In mathematical terms, this could be paraphrased as:
1. The signature is injective;
2. The signature can ‘be calculated algorithmically’ for every vertex; and
3. If for all edges on a vertex, it can be algorithmically decided that a signature is valid for a given vertex,

THEN the signature can be algorithmically calculated from the edges.

A number created with the above properties is also known as a “Gödel number.” A Gödel number of a particular logical formula/statement, or in this case a system of vertices, is the natural number that represents it. It is this corresponding representation that we utilize in the present invention to ascertain the graph isomorphism.

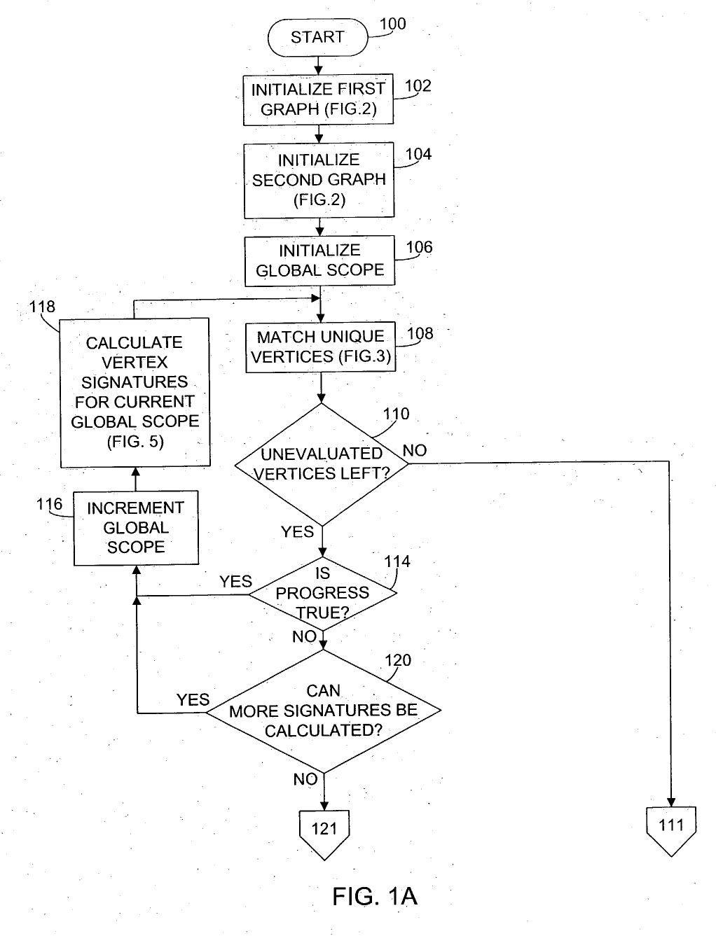

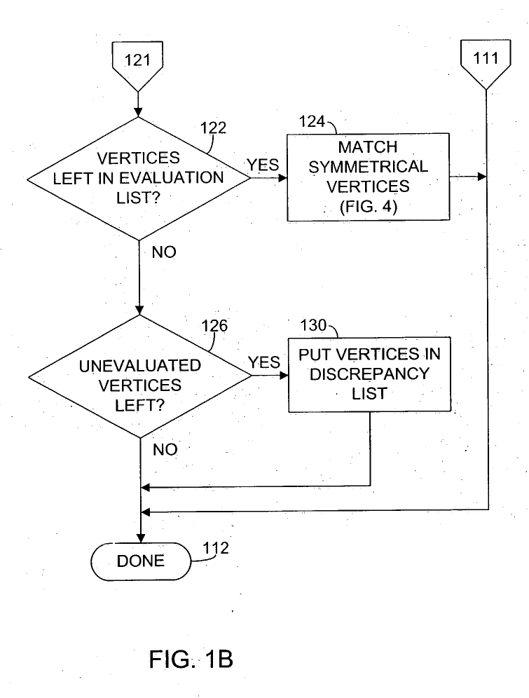

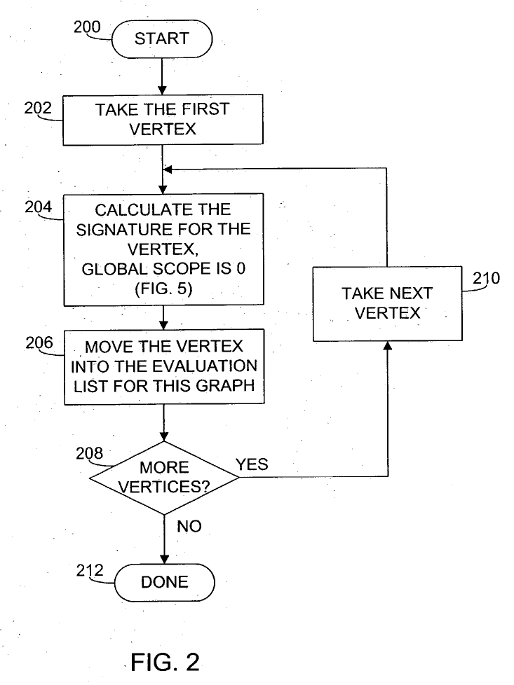

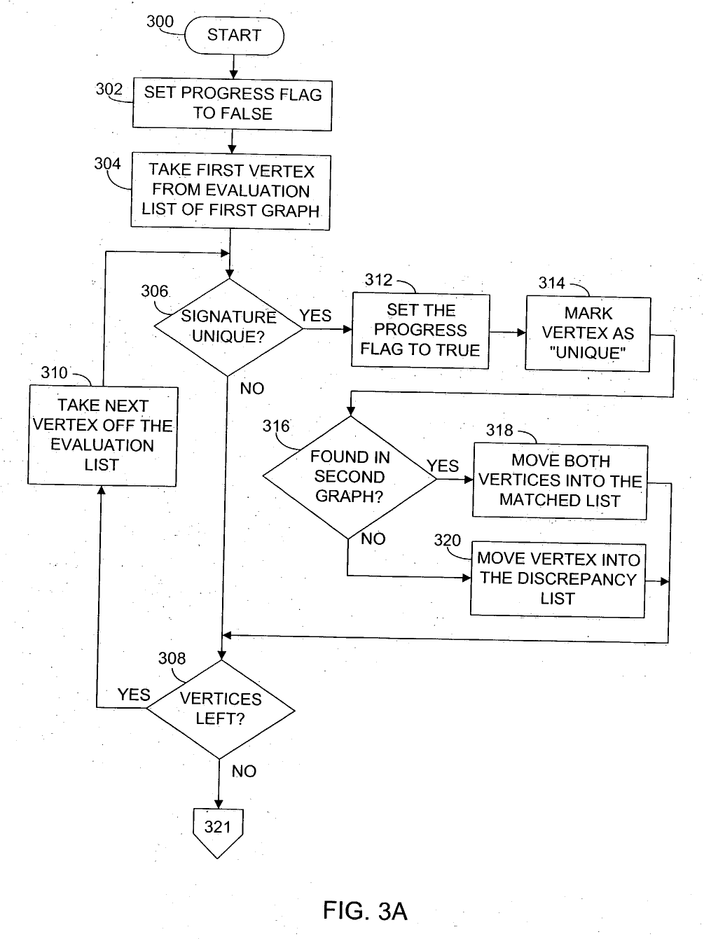

Referring now to the flow diagram of FIG. 1, from a start block 100, the process continues to an initialize first graph block 102, which is shown in expanded form in FIG. 2. The process continues by initializing a second graph in a, block 104. The initialize action of the second graph is again shown in more detail in FIG. 2. The global scope is then initialized in a block 106 by setting the global scope to zero. The next action to occur is in a “match unique vertices” block 108. The action occurring in block 108 is shown in expanded detail in FIG. 3. After the matching of block 108, a decision block 110 ascertains whether or not there are any remaining unevaluated vertices left. If not, the process is completed and the computations end in a DONE block 112. If there are still unevaluated vertices, a decision block 114 checks to determine if a progress flag is still set, to TRUE. If so, the global scope of signature calculations is incremented by “1” in a block 116 and a new set of signatures is calculated for the vertices remaining to be considered in a block 118. The details of the steps occurring in block 118 are expanded in FIG. 5. When all the calculations of block 118 are completed, the unique vertices are again matched in block 108.

If it is determined in decision block 114 that the progress flag is not set to true, a determination is made in a decision block 120, as to whether or not more signatures can be calculated. If so, the process returns to block 116 to increment the global scope of calculations. If there are no more signatures to be calculated, the process checks in a decision block 122 as to whether or not there are any vertices left in the evaluation list. It should be noted at this point that, if components such as identical value capacitors or resistors are connected in parallel, a unique signature cannot be calculated. These parallel-connected components are considered herein to be symmetrical vertices. If, as ascertained in block 122, there are vertices left in the evaluation list, the symmetrical vertices are matched in block 124 before completing the process in block 112. As may be noted, FIG. 4 illustrates in expanded form the steps occurring in block 124. If, in block 122, it is determined that there are no vertices left in the evaluation list, a check is made in a decision block 1-26 if there are any vertices left that have not been evaluated. If so, these are placed in a mismatch or discrepancy list in a block 130 before finishing the process in block 112. If there are no vertices left that have not been evaluated, the process goes directly from block 126 to block 112.

In FIG. 2, the process of initializing a graph starts with a block 200 and then in a block 202 a first vertex is selected. A, signature is calculated for that vertex, using a global scope of zero as shown by a block 204. As also noted, the actions within block 204 are expanded in FIG. 5. After completion of the calculation, the selected (or most recently calculated) vertex is moved-into the evaluation list for this graph as shown in a block 206. A determination is made in a decision block 208 as to whether or not there are any more vertices to be considered. If yes, another vertex is selected, as shown by a block 210 and the action is returned to block 204. This calculation and move process continues until it is determined in block 208 that there are no more vertices to consider. At this time, the initialization process for a given graph is complete as indicated by the DONE block 212.

In FIG. 3, the matching of unique vertices of graphs or circuits being compared start's with a block shown as 300 and proceeds to setting a progress flag to “E” or false in block 302. The next step is to take a first vertex from the list of vertexes to be considered from the first graph as indicated in a block 304. A determination is made in a decision block 306 as to whether the signature for that vertex is unique from the signature of all the rest of the vertexes in the first graph. If it is not, the next step, in a decision block 308, is to determine if there are any more vertices to be considered for the first graph. If there are more vertices to be considered, the next vertex in the evaluation list is selected, as set forth in a block 310, before, returning to decision block 306. If, in decision block 306, it is decided that the signature is unique, the progress flag is set to “T” or true and the vertex is labeled as “unique” as set forth in blocks 312 and 314. A determination is then made in a decision block 316 as to whether this same signature can be found in the second graph. If it can, both of the vertices are considered to be matched and are moved to the matched list as shown in a block 318. The moving of the two vertices to the matched list prevents any further consideration of the prime component for the vertices that are moved. The next step after-block 318 is to check, in block 308, to see if any further vertices are left to be considered; If, in decision block 316, it is determined that the unique signature, found in block 306, cannot be found in the second graph, the process proceeds to block 320 where the vertex having, the unique signature is transferred or moved into a mismatch or discrepancy list. The process then goes to decision block 308.

When no more vertices are left to be considered, as determined in block 308, the first vertex from the evaluation list of the second graph is selected as shown in a block 322. It may be noted at this point that all of the vertices in the first graph that have a unique signature have, been removed from further consideration at this point. In the next few steps, all the vertexes in the second graph that have unique signatures are removed. If it is determined, in a decision block 324, that the signature, of the selected vertex, is not unique from other vertices in the second graph, the process continues to a decision block 326 to ascertain if there are any further vertices left to consider in the second graph. If there are, the next vertex to be considered is selected as set forth in a block 328 before returning to decision block 324. If, in decision block 324, it is determined that the signature is unique; the progress flag is set to “T” or true and the vertex is moved to the discrepancy list whereby that vertex is no longer available for further consideration or processing as set forth in blocks 330 and 332. When all the vertices in the evaluation list have been considered, the process moves to the DONE block 334 as the matching of unique vertices for the presently set global scope has been completed.

In FIG. 4, the matching of symmetrical vertices starts with a block 400 and proceeds to a block 402 where a signature is selected from a vertex in either graph. After selection in blocks 404 and 406, the number of vertices having the signature of the selected vertex is compared in a decision block 408. If the number does not compare, all of the vertices having the signature in question are transferred or moved to the discrepancy list in a block 410 and are no longer considered by the algorithm. The process is then advanced to a decision block 412 to see if there are any further signatures left to be considered of other parallel connected components. If so, the process returns to block 402 to pick another remaining signature until all parallel connected components have been removed from further consideration.

If it is found, in decision block 408, that the number of vertices having a given signature in both graphs are identical, a first vertex is selected from the first graph with the signature in question as stated in block 414. A check is made in a decision block 416 to see if it is found in the second graph. If so, a check is made in a decision block 418 to ascertain if there are more vertices having the given signature in the section. If so, the next vertex in the first graph is selected as set forth in a block 420 before returning to block 416. On the other hand, if it is determined in block 418 there are no more vertices having the given signature to be matched, all the vertices in both graphs are transferred or moved to a matched list as set forth in a block 422 before proceeding to decision block 412 to ascertain if there are any remaining signatures to be considered. When all the signatures in the list of symmetrical vertices have been disposed of, the process is completed in block 424.

The FIG. 5 flow chart for a preferred embodiment method of calculation of a signature starts with a block 500. The purpose of this flow chart is to expand the signature of a given vertex by one additional layer of vertices. The terms “enqueue” and “dequeue,” used in this flow chart, are known in the art as, “append-to-the-end-of-a-list.” and “take-from-the-beginning-of-the-list,” respectively. A given vertex “v” is provided from the list of unevaluated vertices found in block 110. The desired scope “dh” used is that value set by incremental block 116. It may be noted here that the process of FIG. 5, in calculating the signature of a vertex, uses, in a preferred embodiment, a breadth-first type search. The next step, as stated in a block 502, is to initialize a stack which typically is FILO (first in last out) and a, queue, list or database and set a local scope variable to zero. As stated in a block 504, vertex v is enqueued. Next, in a block 506, vertex w is dequeued. A signature is calculated in a following block 508 for vertex w and pushed onto the stack. A determination is made in a decision block 510 as to whether or not the local scope variable is less than the desired or global scope dh. If it is, the local scope variable is incremented as set forth in a block 512 before taking the first neighbor vertex u of vertex w as stated in a block 514. Vertex u is enqueued in a block 516 before checking in a block 518 to ascertain if there are any neighbors left on vertex w. If so, the next neighbor is designated as vertex u in a block 520 and the process returns to block 516. When there are no further neighbors to enqueue, the process continues to a decision block 522 to ascertain if the queue is empty. If not, the process is repeated where a neighboring vertex in the original signature is dequeued in block 506. If the queue checked in block 522 is empty, the next step is a block 524 where the signatures are taken from the stack and the final signature for vertex v is calculated. As may be noted, when it is noted in block 510; that the local scope variable is no longer less than the desired variable, the process goes from block 510 directly to block 524. The flow diagram of steps is then completed at a DONE block 526.

While the signature calculation described above works and has been used, many other approaches may work equally effectively.

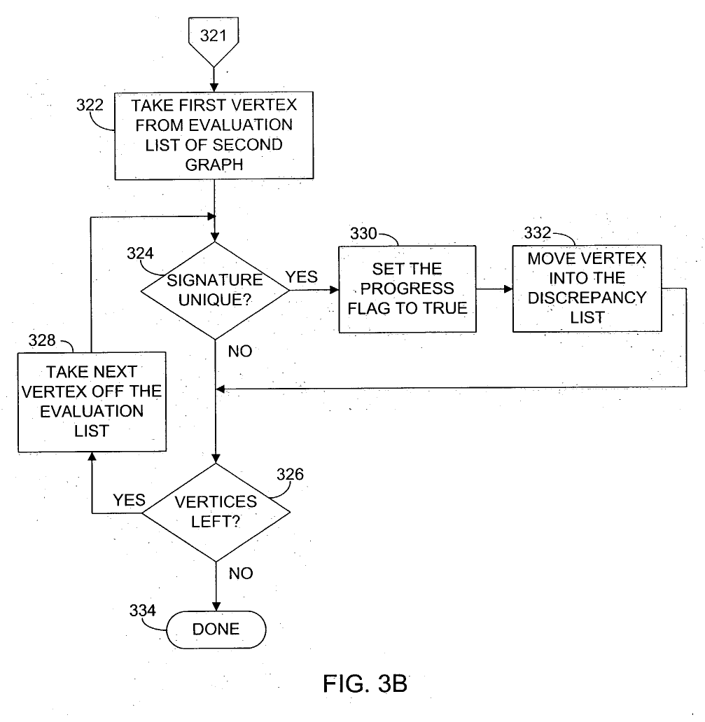

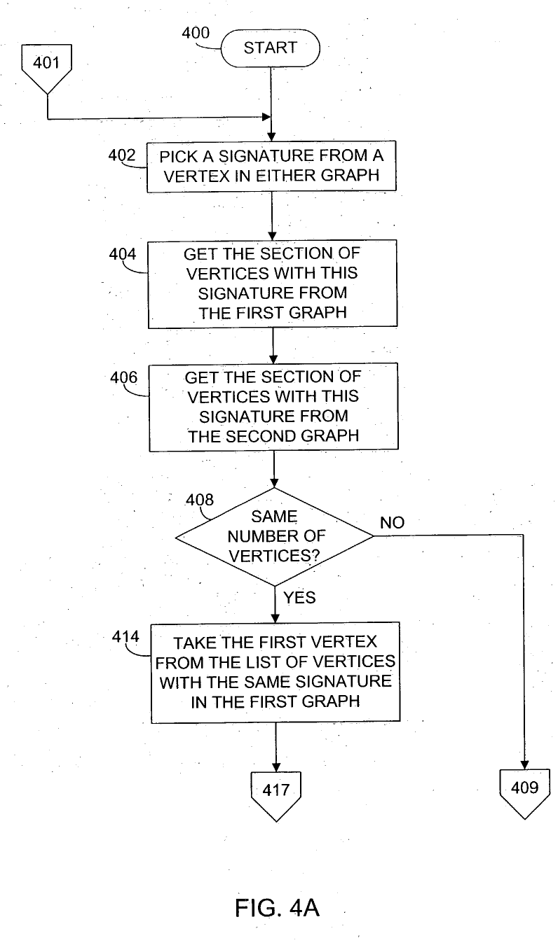

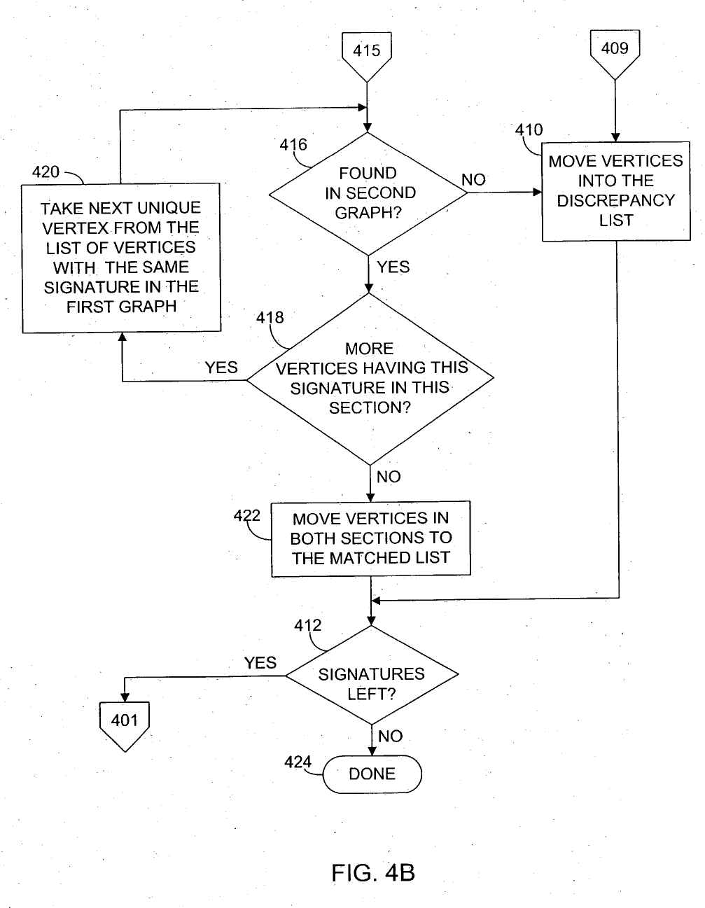

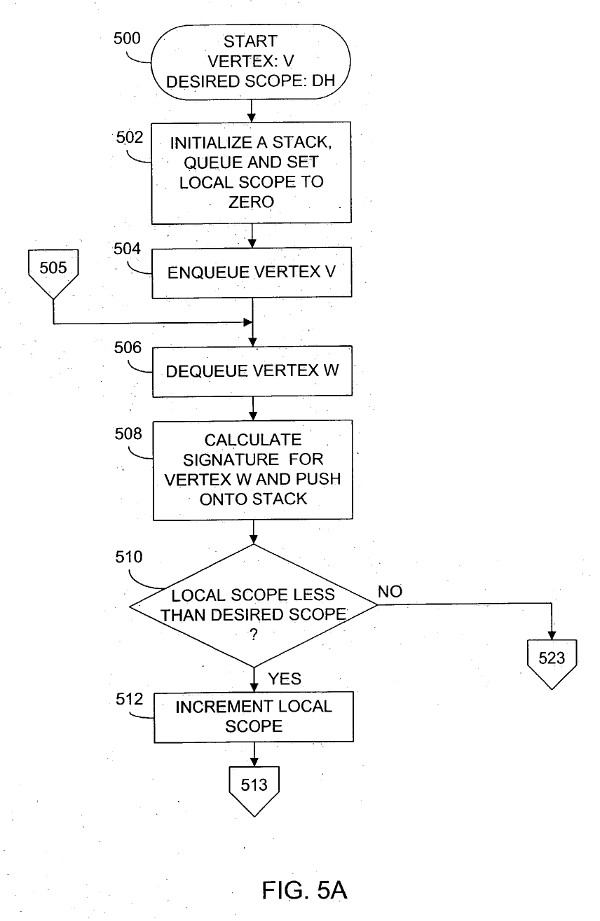

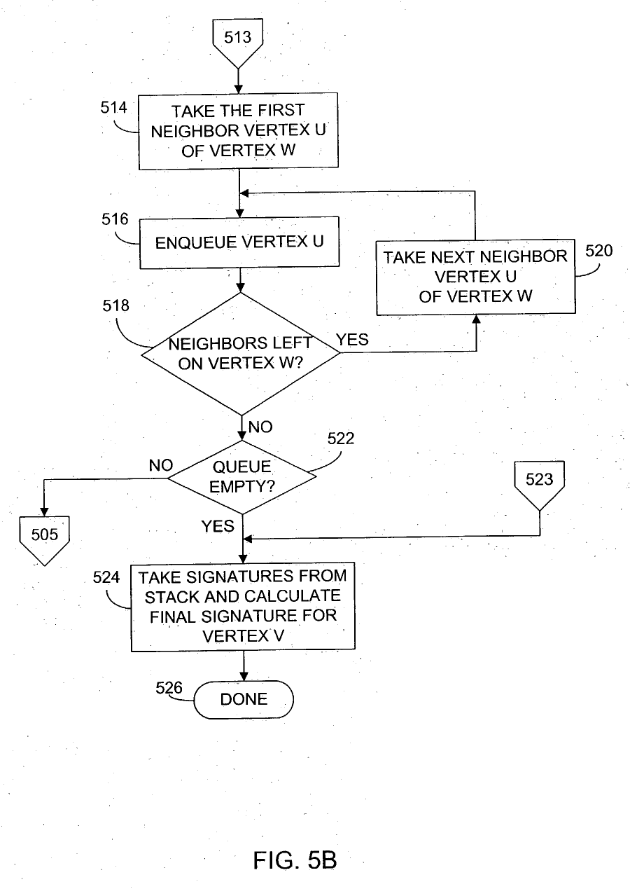

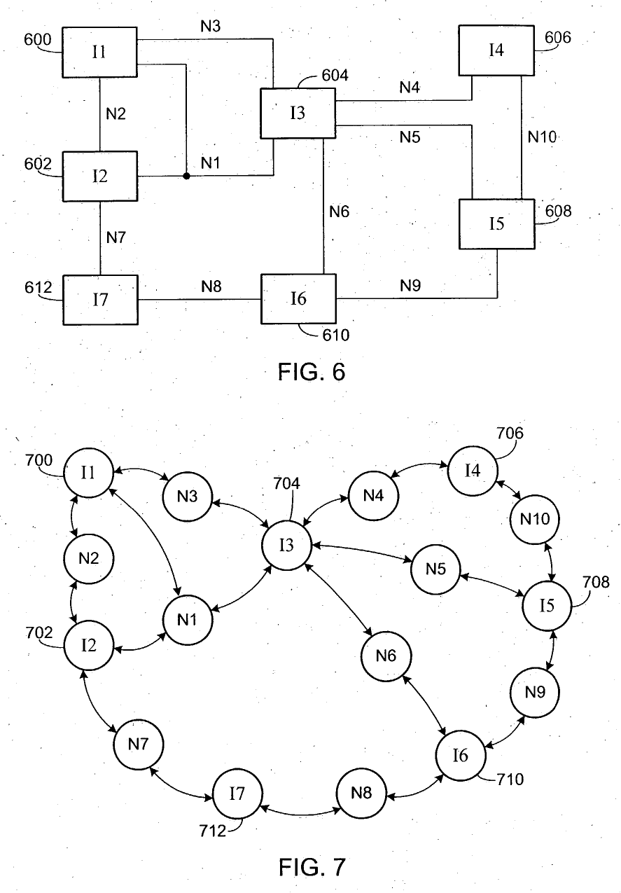

In FIG. 6, a very simple electrical circuit is shown having seven components from I1 to I7. This figure as presented is often referred to, as a schematical network description. These seven components have additional numerical designations of 600, 602, 604, 606, 608, 610, and 612, respectively. Each of the interconnections between components is provided with designations from N1 to N10. A connection N1 is connected to blocks 600, 602 and 604. A lead N2 connects-block 600 to block 602. A lead N3 is connected to only blocks 600 and 604. A lead N4 connects block 604 to block 606. A lead N5 connects block 604 to block 608. A lead N6 interconnects blocks 604 and 610. A lead N7 connects block-602 to block 612. A lead N8 connects block 612 to block 610. A connecting lead N9 interconnects blocks 608 and 610. The lead N10 connects blocks 606 and 608. Since block 600 has three leads, it could be a transistor, a gate or any other 3-lead device. The block 612 has only two leads and could be a resistor, capacitor, diode, and so forth. The block 604 has many leads and could be an integrated circuit.

FIG. 7 comprises the same components and connections as shown in FIG. 6 in a form typically known as a graph representation. Each of the numerical component designators is 100 units higher than the similar component designator used in FIG. 6.

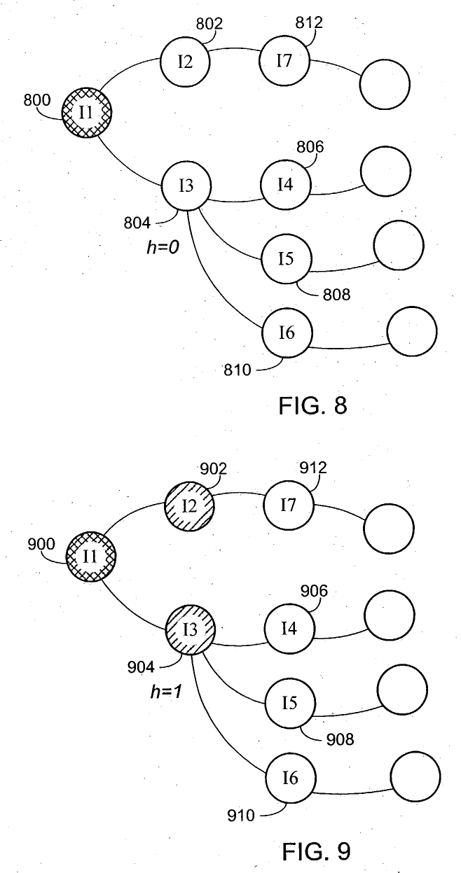

FIG. 8 again illustrates the components of the circuit of FIG. 6 in a form used for explaining the components detailed in a vertex signature for component 800 for a global scope of zero. Such a description or signature would include all the details describing component 800, including the fact that it had a lead N2 connected to component 802, a lead N3 connected to component 804, and a lead N1 connected to both components 802 and 804.

FIG. 9 illustrates the components of the circuit of FIG. 6 in a form used for explaining the components detailed in a vertex signature for component 900 for a global scope of one. Such a description or signature would include all the details describing shaded-components 900, 902 and 904 including the fact that-components 902 and 904 have leads connected to each of the components in the next layer. Each of these components in the next layer is detailed in a manner identical to that described supra.

In summary, the present invention operates to generate a set of signatures for each of the vertices in each of circuits being compared for a global scope of zero. In other words, each component is listed in detail including information identifying every other component or power lead to which that component is connected. Any of these vertex signatures that-are found to be unique in a first circuit and can be matched to a vertex signature in the second circuit cause these vertices to be removed from further consideration in future iterations. Unmatched unique signature vertices ate moved to a discrepancy list and also removed from further consideration in future iterations. The scope is expanded and new sets of signatures are generated in iterative attempts to remove unique signature vertices from further consideration until only symmetrical and unevaluated vertices are left. Matching symmetrical vertices are then removed and the remaining vertices are added to the discrepancy list to complete the process.

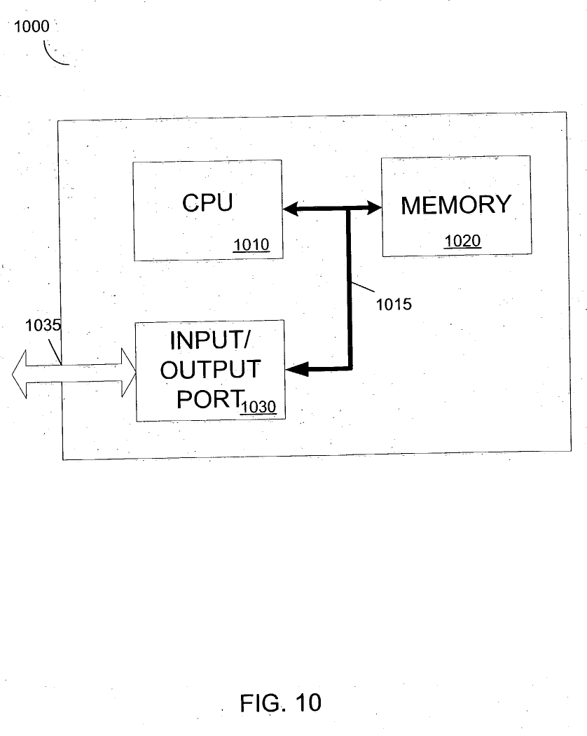

FIG. 10 illustrates a processing system 1000 in which the method of the present invention can be performed. A CPU 1010 is coupled to a memory 1020 through a bus 1015. The bus 1015 is also coupled to an input/output port 10330. The input/output port 1030 sends and receives data over a bus 1035.

In the system 1000, calculations associated with the present invention can occur. This can include initialization of graphs, calculation of vertex signatures, matching vertex signatures, and so on. The input/output port can receive the various lists to be processed. These lists can be stored in the memory 1020, and processed by the CPU 1010, as described above in connection with FIGS. 1 through 9.

Although the invention has been described with reference to a specific embodiment, the description is not meant to be construed in a limiting sense. Various modifications of the disclosed embodiment, as well as alternative embodiments of the invention, will become apparent to persons skilled in the art upon reference to the description of the invention. It, is therefore contemplated that the claims will cover any such modifications or embodiments that fall within the true scope and spirit of the invention.

1. A method of electronically comparing two circuits for identicalness, comprising:
(a) compiling, within one or more-memories, a first list of all components in a first circuit, said first list including data relative to all connections of each component listed, each component in said first list hereinafter being referred to as a vertex;
(b) compiling, within one or more memories, a second list of all components in a second circuit, said second list including data relative all connections of each component listed, each component in said second list hereinafter being referred to as a vertex;
(c) comparing, within one or more processors, each unique vertex in said first list with unique vertexes in said second list;
(d) removing matching vertexes from said first and second lists;
(e) generating, within one or more processors, a discrepancy listing of unmatched unique vertexes in said first and second lists;
(f) removing the unique vertexes from said first and second lists that were placed in the discrepancy listing;
(g) compiling, within one or more memories, new first and second lists of all remaining vertexes of previous first and second lists expanded in scope by one vertex attached to each connection of the previous list stored;
(h) comparing, within one or more processors, each unique vertex in said new first list with unique vertexes in said new second list;
(i) removing matching vertexes from said first and second lists;
(j) adding to said discrepancy listing any remaining unmatched unique vertexes in said new first and second lists;
(k) removing the unique vertexes from said new first and second lists that were added to the discrepancy listing in step (j); and
(l) repeating steps (g) through (k) until all vertexes have been uniquely defined.

2. A method of electronically comparing two circuits, using one or more processors, each comprising a plurality of components, for identicalness where each component commences a generated vertex having a scope of N, where a vertex having N=0 comprises a component with no other components attached to the component's connections and a vertex having N=1 comprises a component with one additional component connected to each connection of prime component, and so forth, comprising the steps of:
(a) compiling an initial first list, within one or more memories, of all vertexes in a first circuit wherein N=0;
(b) compiling an initial second list, within the one or more memories of all vertexes in a second circuit wherein N=0;
(c) removing all unique vertexes that have a corresponding vertex in both said first and second lists;
(d) transferring all remaining unique vertexes in said first and second lists to a discrepancy list within the one or more memories;
(e) compiling new first and second lists, within the one or more memories, of all remaining vertexes wherein N is incremented by “1”;
(f) removing all unique vertexes that have a corresponding vertex in both said new first and second lists;
(g) transferring all remaining unique vertexes in said first and second lists to said discrepancy list; and
(h) repeating steps (e), (f) and (g) until all vertexes are removed from said lists.

3. A method of electronically ascertaining the identicalness of first and second circuits, comprising:
(a) creating, by one or more processors, first and second lists of signatures for all vertexes in first and second circuits respectively, the signatures having a given minimal scope and stored in one or more memories;
(b) deleting any vertexes from further consideration whose signatures are unique and appear identically in both said first and second lists;
(c) transferring a prime component, of any unique signatures, in either of said first and second lists to a discrepancy list stored in the one or more memories;
(d) deleting any vertexes from further consideration whose prime component has been transferred to said discrepancy list;
(e) creating, by the one or more processors, a revised first and second list of signatures for all remaining vertexes in first and second-circuits respectively, after incrementing the scope of the signature;
(f) removing any vertexes from further consideration whose signatures are unique and appear identically in both said revised first and second lists;
(g) transferring a prime component, of any unique signatures, in either of said revised first and second lists to said-discrepancy list stored in the one or more memories;
(h) removing any vertexes from further consideration by, whose prime component has been transferred to said discrepancy list; and
(i) repeating steps (e) through (h) until all vertexes have been removed from further consideration.

4. A method of electronically ascertaining the identicalness of first and second circuits, comprising:
(a) creating, within one or more memories, a first and second list of signatures for vertexes in first and second circuits respectively, the signatures having a given initial scope;
(b) deleting, within the one or more memories, any vertexes from further consideration whose signatures are unique and appear in both said first and second lists;
(c) transferring a prime component, of any remaining unique signatures, to a discrepancy list;
(d) creating, within the one or more memories, revised first and second lists of increased scope signatures for all remaining vertexes in first and second circuits;
(e) removing any vertexes from further consideration whose signatures are unique and appear identically in both said revised first and second lists;
(f) transferring a prime component, of any remaining unique signatures, to said discrepancy list; and
(g) repeating steps (d) through (f) until all vertexes have been removed from further consideration.

5. A computer program product for ascertaining the identicalness of two circuits, the computer, program product having a medium with a computer program embodied thereon, the computer program comprising:
(a) computer code for creating first and second lists of signatures for vertexes in first and second circuits respectively, the signatures having a given initial scope;
(b) computer code for deleting any vertexes from further consideration whose signatures are unique and appear, in both said first and second lists;
(c) computer code for transferring a prime component, of any remaining unique signatures, to a discrepancy list;
(d) computer code for creating revised first and second lists of increased scope signatures for all remaining vertexes in the first and second circuits;
(e) computer code for removing any vertexes from further consideration whose signatures are unique and appear identically in both said revised first and second lists;
(f) computer code for transferring a prime component, of any remaining unique signatures, to said discrepancy list; and
(g) computer code for repeating steps (d) through (f) until all vertexes have been removed from further consideration.

6. Apparatus for electronically ascertaining, the identicalness of two circuits, comprising:
(a) computation means;
(b) first and second lists of signatures for vertexes in first and second circuits respectively, the signatures having a given initial scope and stored within one or more memories;
(c) means, comprising a part of said computation means, for deleting any vertexes from further consideration whose signatures are unique and appear in both said first and second lists;
(d) means, comprising a part of said computation means, for transferring a prime component, of any remaining unique signatures, to a discrepancy list;
(e) means, comprising a part of said computation means, for creating revised first and second lists of increased scope signatures for all remaining vertexes in said two circuits;
(f) means, comprising a part of said computation means, for removing any vertexes from further consideration whose signatures are unique and appear identically in both said revised first and second lists;
(g) means, comprising a part of said computation means, for transferring a prime component, of any remaining unique signatures, to said discrepancy list; and
(h) means, comprising a part of said computation means, for repeating steps (e) through (g) until all vertexes have been removed from further consideration.

7. A system for electronically computing Isomorphic graphs, comprising:
(a) graphical representations of two electrical circuits to be compared for identicalness by at least one processor;
(b) list creation means operable to create first and second lists of signatures for vertexes in first and, second circuits respectively, the signatures having a given initial scope;
(c) detection means operable to delete any vertexes from further consideration whose signatures are unique and appear in both said first and second lists;
(d) removal means operable to transfer a prime component, of any remaining unique signatures, to a discrepancy list;
(e) creation means operable to create revised first and second lists of increased scope signatures for all remaining vertexes in said two-circuits;
(f) further detection means operable to remove any vertexes from further consideration whose signatures are unique and appear identically in both said revised first and second lists;
(g) transfer means operable to transfer a prime component, of any remaining unique signatures, to said discrepancy list; and
(h) repeating means operable to repeat steps (e) through (g) until all vertexes have been removed from further consideration.
